(19) United States
(12) Patent Application Publication
(10) Pub. No.: US 2010/0029459 A1
(43) Pub. Date: Feb. 4, 2010

(54) GLASSES HAVING A REDUCED STRESS-OPTIC COEFFICIENT

(76) Inventors: Josef Wilson Zwanziger, Halifax (CA); Marie Helene Guignard, Halifax (CA)

Correspondence Address: HONIGMAN MILLER SCHWARTZ & COHN LLP, 444 WEST MICHIGAN AVENUE, KALAMAZOO, MI, 49007-3714, US

(21) Appl. No.: 12/309,666

(22) PCT Filed: Jul. 26, 2007
(86) PCT No.: PCT/US07/16784

§ 371 Date: May 29, 2009

Related U.S. Application Data
(60) Provisional application No. 60/833,365, filed on Jul. 26, 2006.
(60) Provisional application No. 60/861,315, filed on Nov. 28, 2006.
(60) Provisional application No. 60/921,670, filed on Apr. 3, 2007.

(51) Int. Cl. C03C 3/04; C03C 3/16; C03C 3/14; C03C 3/12; C03C 3/253

(52) U.S. Cl. 501/42; 501/53; 501/45; 501/49; 501/41

(57) ABSTRACT

The present invention provides novel glasses, methods of formulating glasses having a reduced stress-optic coefficient at visible wavelengths under anisotropic stress, and novel optical systems comprising a such glass.

### CLAIM OF PRIORITY

This application hereby claims the benefit of U.S. provisional patent application Ser. Nos. 60/833,365, which was filed on Jul. 26, 2006; 60/861,315, which was filed on Nov. 28, 2006; and 60/921,670, which was filed on Apr. 3, 2007, each of which is hereby incorporated by reference.

### FIELD OF THE INVENTION

The present invention relates to glasses that are useful in optical systems. The present invention also provides optical systems and methods of preparing glasses useful therein.

### BACKGROUND OF THE INVENTION

Glass is a uniform amorphous solid material, usually produced when a viscous molten material cools to a temperature below its glass transition temperature without sufficient time for a regular crystal lattice to form. When glass is properly annealed, it is optically isotropic.

However, many optically isotropic glasses exhibit optical anisotropy upon the application of anisotropic stress. The optical anisotropy that occurs when a ray of light passing through the material experiences two different refractive indices, and is thereby decomposed into an ordinary ray (polarization perpendicular to the direction of anisotropy) and an extraordinary ray (polarization parallel to the direction of isotropy), is called birefringence. This induction of birefringence on an otherwise optically isotropic material using anisotropic stress termed photoelasticity.

The property of birefringence, or double refraction, is exhibited by many optical crystals. However, photoelastic materials exhibit additional birefringence on the application of anisotropic stress. Therefore, in optically isotropic materials, photoelasticity is the optical property observed when birefringence is induced by the application of anisotropic stress. In photoelastic materials, the magnitude of the refractive indices at each point in the material is directly related to the state of stress at that point.

Engineers and architects use photoelasticity as an experimental method to determine stress distribution in a material. Unlike analytical methods of stress determination, photoelasticity gives a fairly accurate picture of stress distribution even around abrupt discontinuities in a material. The method serves as an important tool for determining the critical stress points in a material and is often used for determining stress concentration factors in irregular geometries. Engineers and architects construct a model from an optically isotropic material such as polycarbonate. To evaluate stress on the model, anisotropic stress is applied, and birefringence is observed at stressed points in the structure.

The degree of the birefringence, and thus, the photoelastic effect in a stressed material is dependent on the stress load applied. Therefore, according to this relationship between stress and optical path difference, the areas of high stress in a sample can be identified by observing a high degree of birefringence.

However, in systems that require optical clarity, (e.g., lens systems, visual displays, light projectors, or fiber optics), photoelasticity is an undesirable property. To achieve uniform optical characteristics, i.e. optical isotropy, birefringence must be avoided.

Typically, application of anisotropic stress to such glass will break optical symmetry. Glasses having a negligible birefringence or no birefringence when subjected to anisotropic stress are useful in optical systems wherein the glass is subjected to an anisotropic stressor (e.g., mechanical stress, thermal stress, or combinations thereof). These optical glasses cap incorporate glass additives, such as lead(II)oxide in concentrations sufficient to provide glasses having reduced or zero photoelasticity when subjected to anisotropic stress.

Lead silicate glasses are of particular industrial importance, because they have optical and electrical uses that take advantage of properties such as a high brilliance factor, large working range, and high electrical resistivity. However, the lead content also results in a loss of chemical durability. As a result, these glasses are easily stained or degraded by environmental factors such as moisture. Moreover, these traditional lead-silica glasses are very expensive.

It is also recognized that lead(II)oxide glass additives are toxic. Lead itself does not break down in the environment. Although exposure to environmental effects such as sunlight, precipitation, and minerals may change the lead compound, lead itself does not decompose or react into biologically harmless compounds. When lead is released to the air, it may travel long distances before settling to the ground. Once lead falls onto soil, it usually sticks to soil particles. Thus, human exposure from lead can occur from breathing lead-contaminated air or dust, eating contaminated foods, or drinking contaminated water.

### BRIEF SUMMARY OF THE INVENTION

The present invention provides a lead free glass comprising at least one glass former, and at least one glass modifier selected from SnO, Sb₂O₃, As₂O₃, and HgO, wherein the glass comprises a sufficient concentration of glass modifier to impart a substantially, optically isotropic response to the glass at visible wavelengths in the presence of an anisotropic stress applied to the glass.

Another aspect of the present invention provides a method of producing glass that comprises the steps of providing a glass former, and providing a glass modifier selected from SnO, Sb₂O₃, As₂O₃, HgO, and any combination thereof, wherein the glass comprises a sufficient concentration of glass modifier to impart a substantially, optically isotropic response to the glass at visible wavelengths in the presence of an anisotropic stress applied to the glass.

Another aspect of the present invention provides a lead free glass consisting essentially of a glass former selected from SiO₂, P₂O₅, B₂O₃, P₂O₅, and any combination thereof; and a glass modifier selected from SnO, Sb₂O₃, As₂O₃, and any combination thereof, wherein the glass modifier is present in sufficient concentration to impart the glass with a stress-optic coefficient from less than about +1.0 Brewsters to about −1.5 Brewsters.

In the methods above, the glass modifier and the glass former can be provided according to an equation:

Σ([x_{fn}×(d_{fn}/N_{Cfn})]+[xₘₙ×(dₘₙ/N_{Cmn})])=0.5 or when one or more of the glass constituents has a dynamic coordination number:

Σ[(xₙ₁×(dₙ₁/N_{Cn1}))+(xₙ₂×(dₙ₂/N_{Cn2})*]=0.5,

wherein X_{fn}, d_{fn}, N_{Cfn}, xₘₙ, dₘₙ, N_{Cmn}, xₙ₁, dₙ₁, N_{Cn1}, xₙ₂, dₙ₂, and N_{Cn2} are defined below.

In either of the glasses or methods above, a glass former can comprise at least one selected from SiO₂, P₂OS, B₂O₃, TeO₂, and GeO₂. Furthermore, the glass can have a sufficient concentration of glass modifier to impart the glass with a stress-optic coefficient from less than about +1.0 Brewster to about −1.5 Brewsters, a stress-optic coefficient of about zero. The glasses and methods above can comprise a glass modifier including SnO having a concentration of at least about 20 mole percent, at least about 40 mole percent, from about 60 mole percent to about 70 mole percent, or about 64 mole percent. The glass former of any of the glass or methods above can include SiO₂, P₂O₅, B₂O₃, TeO₂, or any combination thereof. Alternatively, the glass modifier can comprise Sb₂O₃ having a concentration of at least about 10 mole percent, at least about 30 mole percent, from about 30 mole percent to about 40 mole percent, or about 36 mole percent. Alternatively, the glass modifier can comprise As₂O₃ having a concentration of at least about 20 mole percent, at least about 30 mole percent, from about 50 mole percent to about 60 mole percent, or about 54 mole percent. Alternatively, the glass modifier can comprise HgO having a concentration of at least about 5 mole percent from about 10 mole percent to about 20 mole percent, or about 15 mole percent of HgO.

Another aspect of the present invention provides an optical system-comprising an optical element comprising a glass, wherein the glass comprises TeO₂ and BaO, wherein the concentration of BaO is sufficient to impart a substantially, optically isotropic response to the glass at visible wavelengths when subjected to anisotropic stress.

In these optical systems, the optical element can comprise TeO₂ and a concentration of BaO sufficient to produce an optical stress-optic coefficient in the element from about +0.55 Brewsters and −0.35 Brewsters at visible wavelengths when subjected to anisotropic stress. Or the optical elements can comprise TeO₂ and a mole percent of BaO sufficient to produce an optical stress-optic coefficient in the glass of about zero. Alternatively, the optical element further comprises greater than about 10 mole percent to less than about 20 mole percent of BaO, or from about 5 mole percent to about 25 mole percent of BaO. Any of these optical system can further comprise a glass modifier selected from SnO, Sb₂O₃, As₂O₃, Bi₂O₃, HgO, Al₂O₃, or mixtures thereof. For example, the optical element further comprises a glass former comprising SiO₂, P₂O₅, or combinations thereof. The optical element can further comprise at least one selected from an optical fiber, a lens, a mirror, a window and/or a shield, a light filter, or a display screen, and combinations thereof, or the optical system can comprise a light source capable of emitting visible wavelengths of light. Alternatively, the optical system can comprise a television, a computer monitor, a digital projector, a windshield, a microscope, a detector or combinations thereof, or the optical system can be a television, video monitor, digital projector, window, or optical glasses.

Another aspect of the present invention provides, a method of formulating a glass having a slightly positive, zero, or slightly negative stress-optic coefficient comprising providing a glass former and a glass modifier, wherein either of the glass former or the glass modifier has a dynamic coordination number, and the modifier is present in a concentration that provides the glass with a reduced stress-optic coefficient at visible wavelengths when the glass is subjected to anisotropic stress.

In these methods, glass former can have a dynamic coordination number, and the coordination number decreases when combined with the glass modifier at a sufficient concentration. For example, the glass former can be TeO₂. Furthermore, the glass modifier can comprise BaO. The glass modifier can have a concentration that provides the glass with a stress-optic coefficient from about +0.55 Brewsters to about −0.35 Brewsters at visible wavelengths when the glass is subject to anisotropic stress. For instance, the glass modifier is present in a concentration that provides the glass with a stress-optic coefficient of about 0 Brewsters. The glass modifier is present in a concentration of from about 10 mole percent to less than about 20 mole percent or from about 5 mole percent to about 25 mole percent.

Another aspect of the present invention provides a method of preparing a glass that gives a substantially optically isotropic response in visible wavelengths when subjected to an anisotropic stress, comprising providing greater than about 15 mole percent and less than about 20 mole percent of BaO; and providing from about 80 mole percent or more to about 85 mole percent or less of TeO₂.

Another aspect of the present invention provides a method of producing a glass, comprising providing a glass modifier selected from SnO, Sb₂O₃, As₂O₃, Bi₂O₃, HgO, or mixtures thereof; and providing a glass former selected to produce a glass base of SiO₂, P₂O₅, B₂O₃, TeO₂, GeO₂, or combinations thereof, wherein the glass modifier and the glass former are provided in concentrations according to an equation:

Σ([x_{fn}×(d_{fn}/N_{Cfn})]+[xₘₙ×(dₘₙ/N_{Cmn})])=0.5 or when one or more of the glass constituents has a dynamic coordination number:

Σ[(xₙ₁×(dₙ₁/N_{Cn1}))+(xₙ₂×(dₙ₂/N_{Cn2})*]=0.5,

wherein X_{fn}, d_{fn}, N_{Cfn}, xₘₙ, dₘₙ, N_{Cmn}, xₙ₁, dₙ₁, N_{Cn1}, xₙ₂, dₙ₂, and N_{Cn2} are defined below.

Another aspect of the present invention provides a method of preparing a glass, comprising providing a glass modifier selected from SnO, Sb₂O₃, As₂O₃, Bi₂O₃, HgO, or mixtures thereof, wherein mole percent of the glass modifier provided is sufficient to produce an optical stress-optic coefficient of the glass from about +0.5 Brewsters and about −1.5 Brewsters at visible wavelengths; and providing a glass former selected to produce a glass base of SiO₂, P₂O₅; B₂O₃, TeO₂, GeO₂, or combinations thereof.

### BRIEF DESCRIPTION OF THE FIGURES

FIG. 1 is a graph illustrating birefringence in parts per million, δ/10⁻⁶ as a function of compressive stress in megaPascals, P/MPa, for four exemplary glass samples, the slope of these functions represent the stress-optic coefficient for each of the four glasses, wherein each exemplary glass was formulated using an SnO glass modifier and a P₂O₅ glass former.

FIG. 2 is a graph illustrating birefringence in parts per million, δ/10⁻⁶ as a function of compressive stress, P/MPa, for two exemplary glass samples, the slope of these functions represent the stress-optic coefficient for each of the two glasses, wherein each exemplary glass was formulated using an Sb₂O₃ glass modifier and a B₂O₃ glass former.

FIG. 3 is a graph illustrating birefringence in parts per million, δ/10⁻⁶ as a function of compressive stress, P/MPa, for four exemplary glass samples, the slope of these functions represent the stress-optic coefficient for each of the four glasses, wherein each exemplary glass was formulated using an SnO glass modifier and a SiO₂ glass former.

FIG. 4 is a graph illustrating bond length to coordination number quotients, d/N_{C}, for several exemplary glass additives and the polarity of the stress-optic coefficient associated with each quotient.

FIG. 5 is a graph illustrating birefringence in parts per million δ/10⁻⁶ as a function of compressive stress, P/MPa, for four exemplary glass samples, the slope of these functions represent the stress-optic coefficient for each of the four glasses, wherein each exemplary glass was formulated using a BaO glass modifier and a TeO₂ glass former.

FIG. 6 is a Raman spectrograph of three exemplary glass samples where the bands at 275 cm⁻¹ and 735 cm⁻¹ show increasing amounts of 3 and 3+1 coordinate Te as the BaO concentration increases.

The examples described in the figures above are not intended to limit the scope of the present invention.

### DETAILED DESCRIPTION OF THE INVENTION

As noted above, glass is a uniform amorphous solid material. Being amorphous, glass has short range order, present as deformed randomly interconnected structural formations similar to those found in chemically similar crystal lattices. The result of this, on longer length scales, is an isotropic solid, in particular, an optically isotropic solid.

In isotropic solids, all three principle values of the dielectric tensor are equal. However, when many optically isotropic solids, such as glasses and plastics, are subjected to anisotropic stress, the equality of the dielectric principle values can be lost and thus the dielectric and index of refraction of the material will vary directionally. If the dielectric tensor effects differ in a planar direction in a material such as glass or a crystal, then it is observed that when light passes through the material a portion of its orientation becomes polarized differently, according to the index of refraction in the planar direction, i. This effect is called double refringence, or birefringence. Thus, birefringence is a property by virtue of which a ray of light passing through a birefringent material experiences two refractive indices, and thereby is decomposed into an ordinary ray (polarization perpendicular to the direction of anisotropy) and an extraordinary ray (polarization parallel to the direction of anisotropy).

Photoelastic materials exhibit additional birefringence on the application of anisotropic stress. Therefore, in optically isotropic materials, photoelasticity is the optical property observed when birefringence is induced upon the application of anisotropic stress. In photoelastic materials, the magnitude of the refractive indices at each point in the material is directly related to the state of stress at that point.

Birefringence can be formalized by assigning two different refractive indices to the material for the different polarizations. The birefringence magnitude, Δn, is then defined by:

Δn=nₑ−nₒ (1)

where nₒ and nₑ are the refractive indices for polarizations perpendicular and parallel to the axis along which the anisotropic stress is applied, respectively. Birefringence can also arise in magnetic, not dielectric, materials, but substantial variations in magnetic permeability of materials are rare at optical frequencies.

Furthermore, the degree of the birefringence, and thus, the photoelastic effect in a stressed material is dependent on the stress load applied. This dependence is defined through the stress-optic coefficient C, where

δ=Clσ (2)

wherein δ is the optical path length difference for light polarization along the stress direction; l is the sample thickness; and σ is the applied uniaxial stress. Typical values of C for standard glasses are on the order of 1-10 Brewster (10⁻¹² Pa⁻¹); however, this can vary with the presence of additives (e.g., glass modifiers) in the glass. The stress-optic coefficient, C, is positive when the index of refraction change is greatest in the stress direction and less in the orthogonal direction. When the change is greatest in the orthogonal direction and less in the stress direction, the stress-optical coefficient is negative, and when the index of refraction change is equal in both the stress direction and the orthogonal direction, C is zero.

Therefore, according to the relationship from stress and optical path difference, described in equation (2) above, the areas of high stress in a sample can be identified by observing a high degree of birefringence, or a relatively large magnitude for C.

Without wishing to be bound by theory, it is theorized that the photoelasticity phenomenon is caused by anisotropies in the distribution of electron density and in the response of electrons to the electric field of light under stress. This photoelasticity can be observed when an optical path difference from the ordinary ray and the extraordinary ray with respect to light that has been transmitted by the glass is observed.

As discussed above, the application of anisotropic stress to many glasses will break optical symmetry. Optical glasses can incorporate glass additives, such as lead(II)oxide or other closely related p-block metal oxides, at concentrations sufficient to provide glasses having a reduced or near zero photoelastic response (C≈0). For example, an increase of lead(II)oxide content in the glass past 50 mole percent results in a negative optical response to stress, implying that there has been a greater change in the optical response of the material in the direction perpendicular to the applied stress than in the actual direction of applied stress. As the amount of lead in the glass increases to the 50 mole percent mark, the lead changes from a coordination of 6-8 to 3-4, an indication that the chemical coordination of PbO has an effect on its stress response. These leaded glasses have desirable optical qualities and are useful in optical systems because they remain substantially optically isotropic when subjected to an anisotropic stress.

### I. Definitions

As used herein, a “glass former” or “former” refers to an oxide compound that is useful as an ingredient in glass. Glass formers of the present invention have a d_{f}/N_{Cf} quotient of 0.5 or more, 0.5, or less than 0.5. Exemplary glass formers include SiO₂, P₂O₅, B₂O₃, TeO₂, and GeO₂.

As used herein, a “glass modifier” or “modifier” is an oxide compound that is useful as an ingredient in glass systems, and when combined with a glass former in sufficient concentration, create a glass having a slightly positive stress-optic coefficient, zero stress-optic coefficient, or a slightly negative stress-optic coefficient. In some instances, a glass former reduces the optical path length difference for light polarization along the stress direction. The addition of a glass modifier to a glass former can reduce the stress-optic coefficient in the produced glass to give a slightly positive stress-optic coefficient, a stress-optic coefficient of about zero, or a slightly negative stress-optic coefficient, depending on the concentration of the glass modifier and the concentration of the glass former present in the glass. Glass modifiers of the present invention have a dₘ/N_{Cm} quotient of 0.5 or more, 0.5, or less than 0.5. Exemplary glass modifiers include but are not limited to SnO, Sb₂O₃, As₂O₃, Bi₂O₃, Tl₂O, HgO, BaO, Al₂O₃, SrO, and La₂O₃.

As used herein, “lead free” refers to the absence of lead in a glass product, formulation, or system. Glasses that are lead free comprise only a nominal amount of lead or lead compounds (e.g., less than about 0.5 wt %, less than about 0.1 wt %, or less than about 0.01 wt % of lead or lead compounds).

As used herein, a “glass constituent” refers to either a glass modifier or a glass former as described above.

As used herein, “photoelasticity” is the optical property observed when an isotropic substance becomes birefringent upon the application of anisotropic stress.

As used herein, “birefringence”, or “double refraction”, or “double refringence” refer to the decomposition of a ray of light into two rays (the ordinary ray and the extraordinary ray) when it passes through a material, such as calcite crystals, depending on the polarization of the light.

As used herein, the “stress-optic coefficient” is the quantification of the dependence of the photoelastic effect in a stressed material on the stress load applied. This dependence is defined through the stress-optic coefficient C, where

C=δ/lσ (3)

wherein δ is the optical path length difference for light polarization along the stress direction compared to light polarization perpendicular to it; l is the sample thickness; and σ is the applied uniaxial stress.

As used herein, “ordinary ray” is a light ray polarized in the direction perpendicular to the direction of anisotropy.

As used herein, “extraordinary ray” is a light ray polarized in the direction parallel to the direction of anisotropy.

As used herein, “isotropy” or “isotropic” is the property of being independent of direction.

As used herein, “optical isotropy” or “optically isotropic” is the property of having the same optical properties in every direction. Thus, in optically isotropic materials, all three principle values of the dielectric tensor are equal.

As used herein, “anisotropy” or “anisotropic” is the property of being directionally dependent.

As used herein, “optical anisotropy” or “optically anisotropic” is the property of directionally dependent optical properties. Thus, in optically anisotropic materials, the equality of the dielectric principle values is lost and thus the dielectric and index of refraction of the material varies directionally.

As used herein, “stress” is a measure of the internal distribution of force per unit area within a body that balances and reacts to the loads applied to it. Stress is a tensor quantity. Stress is caused by loading in a single direction and is the load divided by the cross-sectional area,

σ=F/A (4)

wherein σ is stress (units of Pa); F is the load (force, units of Newtons) applied to the one-dimensional body; and A is the cross-sectional area of the body (units of square meters). This expression suggests that the fundamental characteristic that affects the deformation and failure of materials is stress, force divided by the area over which it is applied. This definition of stress, σ=F/A, is sometimes called engineering stress and is used for rating the strength of materials loaded in one dimension. Poisson's ratio, however, reveals that any applied strain will produce a change in the area, A. Engineering stress neglects this change in area.

As used herein, “strain” is the geometrical expression of deformation caused by the action of stress on a physical body. Given that strain results in the deformation of a body, it can be measured by calculating the change in length of a line or by the change in angle from two lines (where these lines are theoretical constructs within the deformed body). The change in length of a line is termed the stretch, absolute strain, or extension, and may be written as δθ. Then the (relative) strain, ∈, is given by

∈=δθ/θ₀ (5)

where θ₀ is the original length of the material. The extension (δθ) is positive if the material has gained length (in tension) and negative if it has reduced length (in compression). Because θ₀ is always positive, the sign of the strain is always the same as the sign of the extension. Strain has no units of measure because in the formula the units of length are cancelled. Dimensions of meters/meter or inches/inch are sometimes used for convenience, but generally units are left off and the strain sometimes is given as a percentage.

As used herein, “visible wavelengths” are wavelengths of electromagnetic radiation falling within the portion of the electromagnetic spectrum that is visible to the human eye. Although there are no numerically exact quantitative boundaries to describe visible wavelengths, a typical human eye will respond to wavelengths from 400 to 700 nm, although some people may be able to perceive wavelengths from 380 to 780 nm.

As used herein, “coordination number” or “N_{C}” is the number of nearest neighbor atoms around a specified atom.

As used herein, “bond distance” or “d” is the distance from two atoms in a molecule or crystal.

As used herein, “oxide-type glass” refers to glasses comprising ingredients selected from oxide compounds, (e.g., mono-oxides, e.g., SnO, HgO, or the like; dioxides, e.g., SiO₂, TeO₂, or the like; trioxide compounds, e.g., Sb₂O₃, B₂O₃, or the like; and others such as P₂O₅).

As used herein the phrase “substantially, optically isotropic response to the glass at visible wavelengths in the presence of an anisotropic stress applied to the glass” refers to an optical response characterized by substantially no birefringence, produced by an anisotropically stressed glass when this glass is conducting visible light. This optical response in the anisotropically stressed glass can be further characterized by a slightly positive, zero, or slightly negative stress-optic coefficient present in the stressed glass. For example, an optically isotropic response in the stressed glass is characterized by the glass having a stress-optic coefficient from about +1.0 Brewsters to about −1.5 Brewsters (e.g., less than about +1.0 Brewsters to about −1.5 Brewsters).

### II. Methods and Glasses Produced Therefrom

A. Methods

The present invention provides methods of formulating a glass having a reduced stress-optic coefficient when subjected to anisotropic stress comprising providing a glass former and a glass modifier, wherein the concentration of the glass modifier is sufficient to impart a substantially, optically isotropic response to the glass at visible wavelengths when anisotropic stress is applied to the glass, i.e., the glass has a slightly positive, zero, or slightly negative stress-optic coefficient.

Formulations for oxide-type glasses having zero or near zero stress-optic coefficients can be approximated using a novel model. In glass having constituents in which non-oxygen atoms of the glass constituents each have static coordination numbers, the sum of the weighted averages of the bond distance divided by the coordination number of the non-oxygen atoms, for each glass constituent equals 0.5. This relationship is mathematically described as:

Σ[xₙ×(dₙ/N_{Cn})]=0.5 (6)

wherein xₙ is the concentration, in mole percent, of an individual glass constituent (e.g., glass former or glass modifier); dₙ is the bond distance, measured in Angstroms, from a non-oxygen atom(s) and an oxygen atom(s) of the individual glass constituent; and N_{Cn} is the coordination number of the non-oxygen atom(s) in the individual glass constituent. The product of the concentration, xₙ, and (dₙ/N_{Cn}) quotient for each glass constituent is totaled, and the sum should equal 0.5 to produce a glass formulation that will result in a glass having a substantially optically isotropic response at visible wavelengths even when the glass is subject to anisotropic stress.

For example, in a two constituent or multi-constituent glass formulation, the expression of equation (6) becomes:

Σ([x_{fn}×(d_{fn}/N_{Cfn})]+[xₘₙ×(dₘₙ/N_{Cmn})])=0.5 (7)

wherein the ([x_{fn}×(d_{fn}/N_{Cfn})]) term represents the product of the concentration, x_{fn}, of each glass former (in mole percent) and its respective (d_{fn}/N_{Cfn}) quotient wherein d_{fn} is the bond distance from the non-oxygen atom(s) and an oxygen atom(s) in the respective glass former, and the N_{Cfn} is the coordination number of the non-oxygen atom(s) in the respective glass former; and the [xₘₙ×(dₘₙ/N_{Cmn})]) term represents the product of the concentration, xₘₙ, of each glass modifier (in mole percent) and its respective (dₘₙ/N_{Cmn}) quotient, wherein, wherein d_{fn} is the bond distance from the non-oxygen atom(s) and an oxygen atom(s) in the respective glass modifier, and the N_{Cfn} is the coordination number of the non-oxygen atom(s) in the respective glass modifier.

In a two constituent glass formulation, the expression of equation (6) becomes:

[x_{f}×(d_{f}/N_{Cf})]+[xₘ×(dₘ/N_{Cm})]=0.5 (8)

wherein x_{f} is the concentration of glass former (in mole percent); d_{f} is the bond distance from the non-oxygen atom(s) and an oxygen atom(s) in the glass former; N_{Cf} is the coordination number of the non-oxygen atom(s) in the glass former; xₘ is the concentration of glass modifier (in mole percent) and where xₘ=(1−x_{f}); dₘ is the bond distance from the non-oxygen atom(s) and the oxygen atom(s) in the oxide compound constituting the modifier; N_{cm} is the coordination number of the non-oxygen atom(s) in the modifier.

However, when the coordination number of a glass constituent is dependent on the composition of the other glass constituents, a condition referred to as “dynamic coordination number”, the expressions in equations (7) and (8) are modified accordingly.

In glasses where one or more glass formers has a dynamic coordination number, i.e., the glass former undergoes a reduction or increase in coordination number, the dₙ/N_{Cn} quotient, in equation (6), for that glass former is:

(d_{f}/N_{Cf})*=[d_{f}/(N_{Cf}°+βₘxₘ)] (9)

where βₘ is the rate of change of coordination number with the addition of glass modifier; and (d_{f}/N_{Cf}°) is the value in the pure glass former. For example, the βₘ term is positive in the case of borates and germanates and negative in the case of tellurites, which means that borates and germanates undergo an increase in coordination number as the concentration of glass modifier increases and tellurites undergoes a reduction in coordination number as the concentration of glass modifier increases.

In glasses where one or more glass modifiers has a dynamic coordination number, i.e., the glass modifier undergoes a reduction or increase in coordination number, the dₙ/N_{Cn} quotient, in equation (6), for that glass former is:

(dₘ/N_{Cm})*=[dₘ/(N_{Cm}°+β_{f}x_{f})] (10)

where β_{f} is the rate of change of coordination number with the addition of glass former; and (dₘ/N_{Cm}°) is the value in the pure glass modifier.

Thus, in a multi-constituent glass, wherein one or more glass constituents has a dynamic coordination number and one or more constituents has a static coordination number, the expression in equation (6) becomes:

Σ[(xₙ₁×(dₙ₁/N_{Cn1}))+(xₙ₂×(dₙ₂/N_{Cn2})*]=0.5 (11)

wherein xₙ₁ is the concentration, in mole percent, of a single glass constituent having a static coordination number, dₙ₁ is the bond distance from the non-oxygen atom(s) and an oxygen atom(s) in the glass constituent; N_{Cn1} is the coordination number of the glass constituent; xₙ₂ is the concentration, in mole percent, of a single glass constituent having a dynamic coordination number; and (dₙ₂/N_{Cn2})* is [d_{c}/(N_{Cc}°+β_{c}x_{c})] where β_{c} is the rate of change of the coordination number with the addition of another glass constituent; and (d_{c}/N_{Cc}°) is the quotient of the bond distance, d_{c}, and the coordination number, N_{Cc}°, of the pure glass constitutent. For example, the β_{c} term is positive in the case of borates and germanates and negative in the case of tellurites, which means that borates and germanates undergo an increase in coordination number as the concentration of glass modifier increases and tellurites undergoes a reduction in coordination number as the concentration of glass modifier increases.

The relationships expressed in equations (6)-(11), above, can be used to generate ab initio glass formulations for glasses having slightly positive stress-optic coefficients, stress-optic coefficients of about zero, or slightly negative stress-optic coefficients. Accordingly, several glass modifiers capable of reducing, eliminating, or otherwise modifying the photoelasticity of a glass possess a dₘ/N_{Cm} quotient that 0.50 or greater, other modifiers have a dₘ/N_{Cm} quotient that is less than 0.5, i.e., slightly less than 0.5, (e.g., from about 0.49 to about 0.40, from about 0.48 to about 0.42, or from about 0.48 to about 0.44). Despite having a dₘ/N_{Cm} quotient less than 0.5, some glass modifiers, when present in sufficient concentration, act to reduce the coordination number of the non-oxygen atom(s) of the glass former(s) to impart the glass with a slightly positive, zero, or negative stress-optic coefficient in the presence of an anisotropic stress.

Using the expressions above, glasses of the present invention can be formulated with a glass former and a glass modifier to produce a glass having a slightly positive stress-optic coefficient, a stress-optic coefficient of about zero, or a slightly negative stress-optic coefficient.

The bond distances and coordination numbers useful for generating ab initio glass formulations, using equations (6)-(11) are presented in Table 1, below.

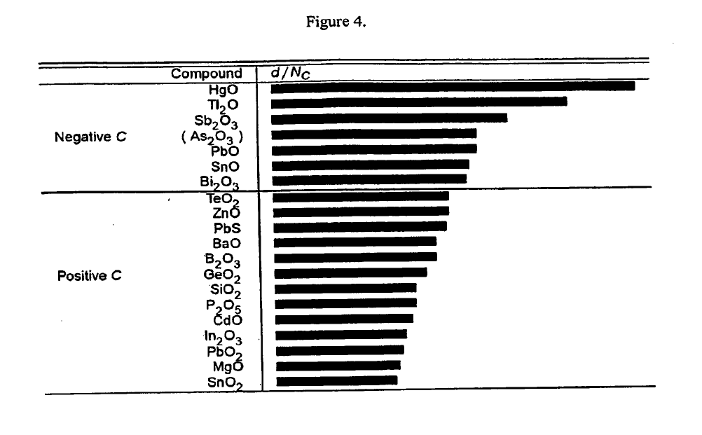

The relationship expressed in equations 6 and 7, above, was used to generate ab initio glass formulations for glasses having slightly positive, about zero, or slightly negative stress-optic coefficients, wherein the glass constituents, i.e., the glass formers and glass modifiers, possess static, i.e., constant, coordination numbers. The bond distances and coordination numbers used for these calculations are described in Table 1, below. A comparative bar graph is presented in FIG. 4. It should be noted that the bond distances and coordination numbers described in Table 1 were empirically determined using crystallographic data.

TABLE 1
Crystalline structure data for exemplary oxide-type glass constituents.

| | | Coordination | |
|---|---|---|---|
| Glass | Bond Distance (d) | Number | Quotient |
| Constituent | in Angstroms | (N_{C}) | (d/N_{C}) |
| HgO | 2.067 | 2 | 1.03 |
| Tl₂O | 2.517 | 3 | 0.84 |
| Sb₂O₃ | 2.022 | 3 | 0.67 |
| As₂O₃ | 1.75 | 3 | 0.58 |
| PbO | 2.326 | 4 | 0.58 |
| SnO | 2.224 | 4 | 0.56 |
| Bi₂O₃ | 2.198 | 4 | 0.55 |
| TeO₂ | 2 | 4 | 0.50 |
| ZnO | 1.988 | 4 | 0.50 |
| PbS | 2.967 | 6 | 0.49 |
| BaO | 2.74 | 6 | 0.46 |
| B₂O₃ | 1.366 | 3 | 0.46 |
| GeO₂ | 1.717 | 4 | 0.43 |
| SiO₂ | 1.609 | 4 | 0.40 |
| P₂O₅ | 1.6 | 4 | 0.40 |
| CdO | 2.347 | 6 | 0.39 |
| In₂O₃ | 2.21 | 6 | 0.37 |
| PbO₂ | 2.15 | 6 | 0.36 |
| MgO | 2.1085 | 6 | 0.35 |
| SnO₂ | 2.055 | 6 | 0.34 |

In many examples, the glass modifiers useful in the present invention possess a dₘ/N_{Cm} (expressed as d/N_{C} in FIG. 4) quotient that at least 0.50. In other examples, the glass modifiers possess a dₘ/N_{Cm} quotient that is greater than 0.50 (e.g., greater than about 0.51, or from about 0.51 to about 0.57). In still other examples, the glass modifiers possess a dₘ/N_{Cm} quotient that is less than 0.50 (e.g., from about 0.49 to about 0.40, from about 0.48 to about 0.42, or from about 0.48 to about 0.44); however, when combined with a sufficient concentration of a certain glass former or a certain concentration of a second glass modifier, the original glass modifier undergoes a reduction in coordination number of its non-oxygen atom(s) that provides a dₘ/N_{Cm} quotient of about 0.5 or greater than 0.5.

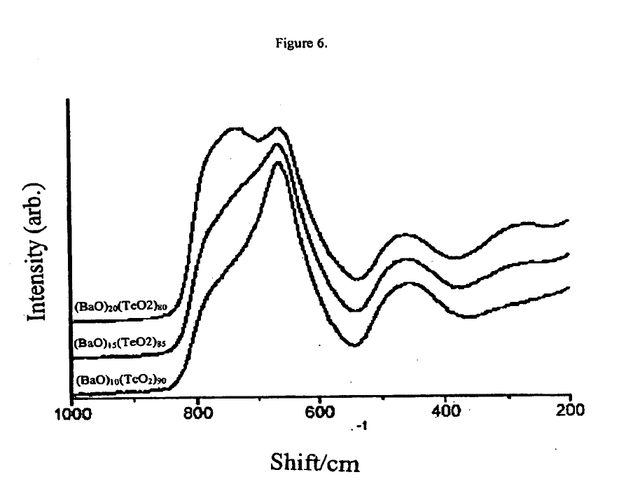

For example, in a two constituent glass, wherein one of the glass constituents undergoes a reduction in coordination number, includes BaO—TeO₂ glass. In pure TeO₂ glasses, the Te atom has a coordination number of 4. However, referring to FIG. 6, when the concentration of BaO in the glass increases, the coordination number for Te decreases. This decrease in coordination number was observed using Raman Spectroscopy. FIG. 6 shows the Raman spectra of several exemplary glass samples wherein the bands at 275 cm⁻¹ and 735 cm⁻¹ show increasing amounts of 3 and 3+1 coordinate Te as the concentration of BaO increases.

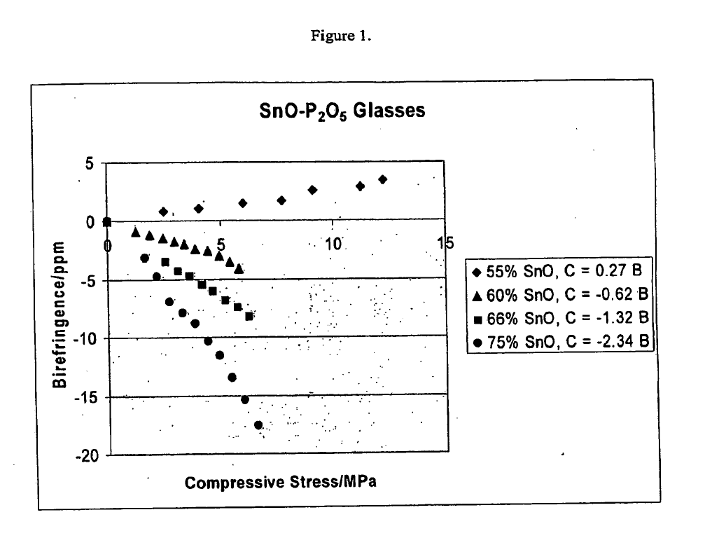

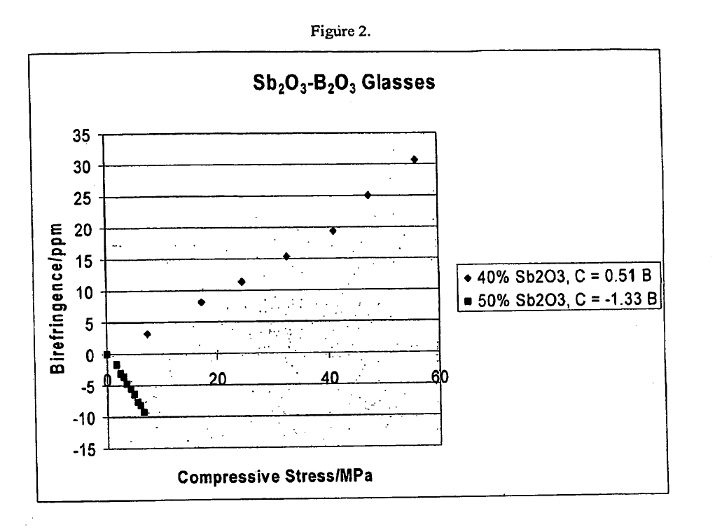

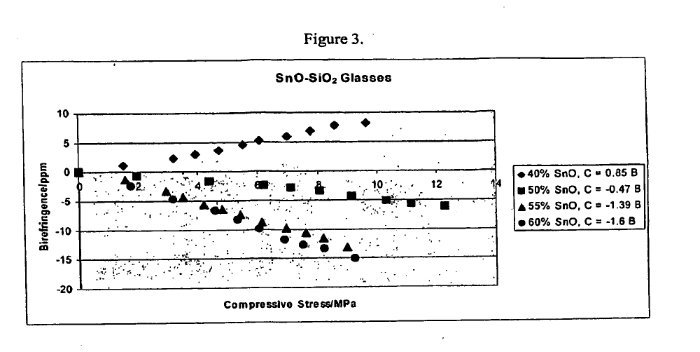

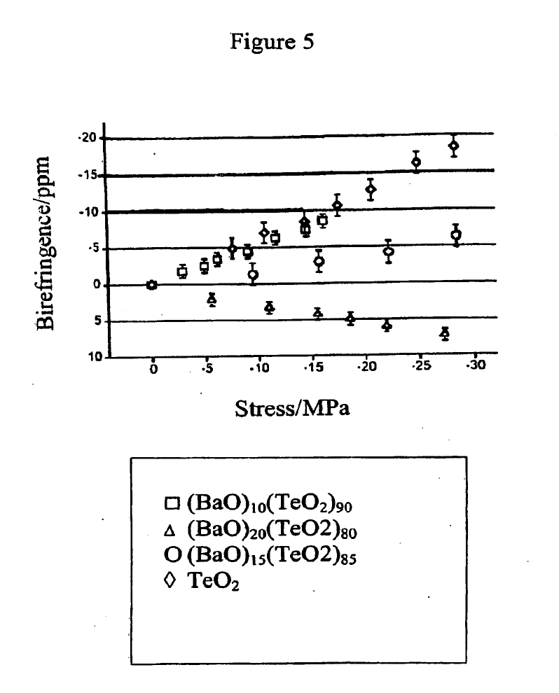

Referring to FIGS. 1-3 and 5, it is noted that a glass modifier having a static or dynamic dₘ/N_{Cm} quotient above 0.50, may be used, in certain concentrations and with certain glass formers, to formulate a glass having a slightly positive stress-optic coefficient, zero stress-optic coefficient, or slightly negative stress-optic coefficient. When more than one glass modifier or more than one glass former is used in the preparation of a glass, the approximate concentration of glass modifier required depends upon the properties (e.g., the coordination number, bond length, or both) of the added glass former or glass modifier and how these properties affect the formulation defined by equation (6). For instance, if an additional glass constituent having a dₙ/N_{Cn} quotient below 0.50 is added to a glass formulation having a stress-optic coefficient of about zero, a higher concentration of the original glass modifier will be required to restore the stress-optic coefficient of the glass produced from the adjusted formulation to zero. If an additional glass constituent having a dₙ/N_{Cn} quotient above 0.50 is added to a glass formulation that produces a glass having a stress-optic coefficient of about zero, a smaller concentration of original glass modifier will be required to restore the stress-optic coefficient of the glass produced from the adjusted formulation to zero.

Using the expressions above, glasses of the present invention can be formulated with a glass former and a glass modifier to produce a glass having a slightly positive stress-optic coefficient, a stress-optic coefficient of zero, or a slightly negative stress-optic coefficient.

In accordance with the model described above, one aspect of the present invention provides a method of producing a lead free glass comprising providing at least one glass former; and providing at least one glass modifier wherein the glass modifier and the glass former are provided according to an equation:

Σ([x_{fn}×(d_{fn}/N_{Cfn})]+[xₘₙ×(dₘₙ/N_{Cmn})])=0.5

or when one or more of the glass constituents has a dynamic coordination number:

Σ([xₙ₁×(dₙ₁/N_{Cn1})]+[xₙ₂×(dₙ₂/N_{Cn2})]*=0.5

wherein x_{fn}, d_{fn}, N_{Cfn}, x_{fm}, d_{fm}, N_{Cmn}, xₙ₁, dₙ₁, N_{Cn1}, xₙ₂, and (dₙ₂/N_{Cn2})* are defined above. In one example, the glass modifier is at least one selected from SnO, Sb₂O₃, As₂O₃, HgO, Bi₂O₃, Tl₂O, Al₂O₃, BaO, SrO, and La₂O₃. For instance, the glass modifier is at least one selected from SnO, Sb₂O₃, As₂O₃, HgO, and BaO. In another instance, the glass modifier is at least one selected from SnO, Sb₂O₃, As₂O₃, HgO. In several examples, the glass former is at least one selected from SiO₂, P₂O₅, B₂O₃, TeO₂, and GeO₂. In one example, the glass modifier comprises SnO. For example, the glass comprises at least about 10 mole percent of SnO (e.g., at least about 20 mole percent, at least about 40 mole percent, at least about 50 mole percent, or at least about 60 mole percent). In another example, the glass comprises from about 40 mole percent to about 50 mole percent (e.g., from about 42 mole percent to about 46 mole percent), or from about 60 mole percent to about 70 mole percent of SnO (e.g., from about 62 mole percent to about 68 mole percent). In another example, the glass comprises about 44 mole percent of SnO or about 64 mole percent of SnO.

Another aspect of the present invention provides a method of producing a lead free glass comprising providing at least one glass former; and providing at least one glass modifier selected from SnO, Sb₂O₃, As₂O₃, HgO, Bi₂O₃, Tl₂O, Al₂O₃, BaO, SrO, and La₂O₃, (e.g., SnO, Sb₂O₃, As₂O₃, and HgO), wherein the glass comprises a sufficient concentration of glass modifier to impart a substantially, optically isotropic response to the glass at visible wavelengths in the presence of an anisotropic stress applied to the glass, i.e., the glass comprises a sufficient concentration of glass modifier to provide the glass with a slightly positive, zero, or slightly negative stress-optic coefficient. In several examples, the glass former is SiO₂, P₂O₃, B₂O₃, TeO₂, GeO₂, or any combination thereof. In other examples, the glass further comprises a sufficient concentration of glass modifier to impart the glass with a stress-optic coefficient from less than about +1.0 Brewster to about −1.5 Brewsters (e.g., from about +0.95 Brewsters to about −1.45 Brewsters, from about +0.75 Brewsters to about −1.25 Brewsters, from about +0.1 Brewsters to about −0.1 Brewsters, from about +0.09 Brewsters to about −0.09 Brewsters, from about +0.08 Brewsters and −0.08 Brewsters, from about +0.07 Brewsters and −0.07 Brewsters, from about +0.06 Brewsters and −0.06 Brewsters, or from about +0.02 Brewsters and −0.02 Brewsters). For instance, the glass comprises a sufficient concentration of glass modifier to impart the glass with a stress-optic coefficient of about zero. In one example, the glass modifier comprises SnO. For example, the glass comprises at least about 10 mole percent of SnO (e.g., at least about 20 mole percent, at least about 40 mole percent, at least about 50 mole percent, or at least about 60 mole percent). In another example, the glass comprises from about 40 mole percent to about 50 mole percent (e.g., from about 42 mole percent to about 46 mole percent), or from about 60 mole percent to about 70 mole percent of SnO (e.g., from about 62 mole percent to about 68 mole percent).

In another example, the glass comprises about 44 mole percent of SnO or about 64 mole percent of SnO. In other examples, the glass former comprises SiO₂, P₂O₅, B₂O₃, TeO₂, or any combination thereof.

In other methods the glass modifier comprises Sb₂O₃. For example, the glass modifier comprises Sb₂O₃, and the resulting glass further comprises at least about 10 mole percent of Sb₂O₃, (e.g., at least about 20 mole percent Sb₂O₃, or at least about 30 mole percent Sb₂O₃). In one example, the glass modifier comprises Sb₂O₃, and the glass further comprises from about 30 mole percent to about 40 mole percent of Sb₂O₃. For instance, the glass modifier comprises Sb₂O₃, and the resulting glass further comprises about 36 mole percent of Sb₂O₃.

In other methods, the glass modifier comprises As₂O₃. For example, the glass modifier comprises As₂O₃, and the resulting glass further comprises at least about 20 mole percent of As₂O₃. In some instances, the glass modifier comprises As₂O₃, and the resulting glass further comprises at least about 30 mole percent of As₂O₃. In other instances, the glass modifier comprises As₂O₃, and the resulting glass further comprises from about 50 mole percent to about 60 mole percent of As₂O₃. In some examples, the glass modifier comprises As₂O₃, and the resulting glass further comprises about 54 mole percent of As₂O₃.

In other methods, the glass modifier comprises HgO. In some examples, the glass modifier comprises HgO, and the resulting glass further comprises at least about 5 mole percent of HgO. For instance, the glass modifier comprises HgO, and the resulting glass further comprises from about 10 mole percent to about 20 mole percent of HgO. In other instances, the glass modifier comprises HgO, and the resulting glass comprises about 15 mole percent of HgO.

The methods discussed above can be used to formulate and produce novel glasses of the present invention. Some of these glasses are discussed below.

B. Glass

Another aspect of the present invention provides a glass comprising a glass modifier selected from SnO, Sb₂O₃, As₂O₃, HgO, Bi₂O₃, Tl₂O, Al₂O₃, BaO, SrO, and La₂O₃, (e.g., SnO, Sb₂O₃, As₂O₃, HgO, and BaO; or SnO, Sb₂O₃, As₂O₃, and HgO); and a glass former, wherein the glass comprises a sufficient concentration of glass modifier to impart a substantially, optically isotropic response to the glass at visible wavelengths in the presence of an anisotropic stress applied to the glass, i.e., the glass comprises a sufficient concentration of glass modifier to provide the glass with a slightly positive, zero, or slightly negative stress-optic coefficient. In several examples, the glass former is SiO₂, P₂O₅, B₂O₃, TeO₂, GeO₂, or any combination thereof. In other examples, the glass further comprises a sufficient concentration of glass modifier to impart the glass with a stress-optic coefficient from less than about +1.0 Brewster to about −1.5 Brewster (e.g., from about +0.95 Brewsters to about −1.45 Brewsters, from about +0.75 Brewster to about −1.25 Brewsters, from about +0.1 Brewsters to about −0.1 Brewsters, from about +0.09 Brewsters to about −0.09 Brewsters, from about +0.08 Brewsters and −0.08 Brewsters, from about +0.07 Brewsters and −0.07 Brewsters, from about +0.06 Brewsters and −0.06 Brewsters, or from about +0.02 Brewsters and −0.02 Brewsters). For instance, the glass comprises a sufficient concentration of glass modifier to impart the glass with a stress-optic coefficient of about zero.

In one embodiment, the glass comprises at least one glass modifier selected from SnO, Sb₂O₃, As₂O₃, Bi₂O₃, Tl₂O, and HgO. In another embodiment, the optical glass comprises a glass modifier that is a mixture of SnO, Sb₂O₃, As₂O₃, Bi₂O₃, Tl₂O, or HgO, wherein the mole percent of each constituent approximately follows the ratio of 1:1:0.8:0.6:0.3:0.2 for Bi₂O₃:SnO:As₂O₃:Sb₂O₃:Tl₂O:HgO.

In one example, the glass modifier comprises SnO. For example, the glass comprises at least about 10 mole percent of SnO (e.g., at least about 20 mole percent, at least about 25 mole percent, at least about 30 mole percent, at least about 35 mole percent, at least about 40 mole percent, at least about 50 mole percent, or at least about 60 mole percent). In another example, the glass comprises from about 40 mole percent to about 50 mole percent (e.g., from about 42 mole percent to about 46 mole percent), or from about 60 mole percent to about 70 mole percent of SnO (e.g., from about 62 mole percent to about 68 mole percent). In another example, the glass comprises about 44 mole percent of SnO or about 64 mole percent of SnO. In other examples, the glass former comprises at least one selected from SiO₂, P₂O₅, B₂O₃, and TeO₂.

In several embodiments, the glass comprises a glass modifier selected from Sb₂O₃. In other embodiments, the glass has at least about 10 mole percent, (e.g., at least about 15 mole percent, at least about 20 mole percent, or at least about 25 mole percent), of Sb₂O₃. Other exemplary glasses have at least about 30 mole percent, (e.g., at least about 32 mole percent, or at least about 34 mole percent), of Sb₂O₃.

In several embodiments, the glass comprises a glass modifier selected from As₂O₃. In other embodiments, the glass has at least about 20 mole percent, (e.g., at least about 22 mole percent, at least about 25 mole percent, or at least about 27 mole percent), of As₂O₃. Other exemplary glasses have at least about 30 mole percent, (e.g., at least about 35 mole percent, at least about 40 mole percent, or at least about 45 mole percent), of As₂O₃.

In several embodiments, the glass comprises a glass modifier selected from HgO. In other embodiments, the glass has at least about 5 mole percent, (e.g., at least about 6 mole percent, at least about 7 mole percent, or at least about 8 mole percent), of HgO.

In several embodiments, the glass comprises a glass modifier selected from Bi₂O₃. In other embodiments, the glass has at least about 35 mole percent, (e.g., at least about 40 mole percent, at least about 42 mole percent, or at least about 45 mole percent), of Bi₂O₃.

In several embodiments, the glass comprises a glass modifier selected from Tl₂O. In other embodiments, the glass has at least about 10 mole percent, (e.g., at least about 15 mole percent, at least about 20 mole percent, or at least about 25 mole percent), of Tl₂O.

One example provides a glass comprising a glass modifier selected from SnO; and a glass former selected from SiO₂, P₂O₅, or combinations thereof, wherein the glass comprises from about 60 mole percent to about 70 mole percent, (e.g., from about 61 to about 69 mole percent, from about 62 mole percent to about 68 mole percent, or from about 63 mole percent to about 67 mole percent), of SnO. In another example, the glass comprises a glass modifier selected from SnO; and a glass former selected from SiO₂, P₂O₅, or combinations thereof, wherein the glass comprises about 64 mole percent, (e.g., about 63 mole percent, or about 65 mole percent), of SnO.

Another example provides a glass comprising a glass modifier selected from Sb₂O₃; and a glass former selected from SiO₂, P₂O₅, or combinations thereof, wherein the glass comprises from about 30 mole percent to about 40 mole percent, (e.g., from about 31 mole percent to about 39 mole percent, from about 32 mole percent to about 38 mole percent, or from about 33 mole percent to about 37 mole percent), of Sb₂O₃. In a more example, the glass comprises a glass modifier selected from Sb₂O₃; and a glass former selected from SiO₂, P₂O₅, or combinations thereof, wherein the glass comprises about 36 mole percent, (e.g., about 34 mole percent, or about 37 mole percent), of Sb₂O₃.

Another example provides a glass comprising a glass modifier selected from As₂O₃; and a glass former selected from SiO₂, P₂O₅, or combinations thereof, wherein the glass comprises from about 50 to about 60 mole percent, (e.g., from about 51 to about 59 mole percent, from about 52 to about 58 mole percent, or from about 53 to about 57 mole percent), of As₂O₃. In a more example, the glass comprises a glass modifier selected from As₂O₃; and a glass former selected from SiO₂, P₂O₅, or combinations thereof, wherein the glass comprises about 54 mole percent, (e.g., about 53 mole percent, or about 55 mole percent), of As₂O₃.

Another example provides a glass comprising a glass modifier selected from HgO; and a glass former selected from SiO₂, P₂O₅, or combinations thereof, wherein the glass comprises from about 10 to about 20 mole percent, (e.g., from about 11 to about 19 mole percent, from about 12 to about 18 mole percent, or from about 13 to about 17 mole percent), of HgO. In another example, the glass comprises a glass modifier selected from HgO; and a glass former selected from SiO₂, P₂O₅, or combinations thereof, wherein the glass comprises about 15 mole percent, (e.g., about 14 mole percent, or about 16 mole percent), of HgO.

Another example provides a glass comprising a glass modifier selected from Bi₂O₃; and a glass former selected from SiO₂, P₂O₅, or combinations thereof, wherein the glass comprises from about 60 to about 70 mole percent, (e.g., from about 61 to about 69 mole percent, from about 62 to about 68 mole percent, or from about 63 to about 67 mole percent), of Bi₂O₃. For instance, example, the glass comprises a glass modifier selected from Bi₂O₃; and a glass former selected from SiO₂, P₂O₅, or combinations thereof, wherein the glass comprises about 66 mole percent, (e.g., about 65 mole percent, or about 67 mole percent), of Bi₂O₃.

Another example provides a glass comprising a glass modifier selected from Tl₂O; and a glass former selected from SiO₂, P₂O₅, or combinations thereof, wherein the glass comprises from about 15 to about 30 mole percent, (e.g., from about 17 to about 28 mole percent, from about 19 to about 26 mole percent, or from about 20 to about 24 mole percent), of Tl₂O. In another example, the glass comprises a glass modifier selected from Tl₂O; and a glass former selected from SiO₂, P₂O₅, or combinations thereof, wherein the glass comprises about 22 mole percent, (e.g., about 21 mole percent, or about 23 mole percent), of Tl₂O.

One example provides a glass comprising a glass modifier selected from SnO; and a glass former selected from B₂O₃, wherein the glass comprises from about 40 mole percent to about 50 mole percent, (e.g., from about 41 mole percent to about 49 mole percent, from about 42 mole percent to about 48 mole percent, or from about 43 mole percent to about 47 mole percent), of SnO. For instance, example, the glass comprises a glass modifier selected from SnO; and a glass former selected from B₂O₃, wherein the glass comprises about 44 mole percent, (e.g., about 43 mole percent, or about 45 mole percent), of SnO.

Another example provides a glass comprising a glass modifier selected from Sb₂O₃; and a glass former selected from B₂O₃, wherein the glass comprises from about 15 mole percent to about 25 mole percent, (e.g., from about 16 to about 24 mole percent, from about 17 mole percent to about 23 mole percent, or from about 18 mole percent to about 22 mole percent), of Sb₂O₃. In another example, the glass comprises a glass modifier selected from Sb₂O₃; and a glass former selected from B₂O₃, wherein the glass comprises about 36 mole percent, (e.g., about 34 mole percent, or about 37 mole percent), of Sb₂O₃.

Another example provides a glass comprising a glass modifier selected from As₂O₃; and a glass former selected from B₂O₃, wherein the glass comprises from about 30 to about 40 mole percent, (e.g., from about 31 to about 39 mole percent, from about 32 to about 38 mole percent, or from about 33 to about 37 mole percent), of As₂O₃. In another example, the glass comprises a glass modifier selected from As₂O₃; and a glass former selected from B₂O₃, wherein the glass comprises about 34 mole percent, (e.g., about 33 mole percent, or about 35 mole percent), of As₂O₃.

Another example provides a glass comprising a glass modifier selected from HgO; and a glass former selected from B₂O₃, wherein the glass comprises from about 5 to about 10 mole percent, (e.g., from about 6 to about 9 mole percent), of HgO. In a more example, the glass comprises a glass modifier selected from HgO; and a glass former selected from B₂O₃, wherein the glass comprises about 8 mole percent, (e.g., about 14 mole percent, or about 16 mole percent), of HgO.

Another example provides a glass comprising a glass modifier selected from Bi₂O₃; and a glass former selected from B₂O₃, wherein the glass comprises from about 40 to about 50 mole percent, (e.g., from about 41 to about 49 mole percent, or from about 42 to about 48 mole percent), of Bi₂O₃. In another example, the glass comprises a glass modifier selected from Bi₂O₃; and a glass former selected from B₂O₃, wherein the glass comprises about 47 mole percent, (e.g., about 46 mole percent, or about 48 mole percent), of Bi₂O₃.

Another example provides a glass comprising a glass modifier selected from Tl₂O; and a glass former selected from B₂O₃, wherein the glass comprises from about 5 to about 20 mole percent, (e.g., from about 6 to about 19 mole percent, from about 7 to about 18 mole percent, or from about 8 to about 17 mole percent), of Tl₂O. In another example, the glass comprises a glass modifier selected from Tl₂O; and a glass former selected from B₂O₃, wherein the glass comprises about 12 mole percent, (e.g., about 11 mole percent, or about 13 mole percent), of Tl₂O.

Another aspect of the present invention provides multi-component glass systems having reduced stress-optic coefficients. In several embodiments, the glass comprises a glass former and a glass modifier wherein the glass modifier is present in sufficient concentration to provide the glass with a reduced stress-optic coefficient. In several embodiments, the glass former is TeO₂. In other embodiments, the glass modifier is at least one selected from BaO, Al₂O₃, SrO, and La₂O₃.

In one embodiment, the glass comprises TeO₂, BaO, and Al₂O₃, wherein the BaO and Al₂O₃ are present in sufficient concentrations to provide the glass system with a reduced stress-optic coefficient. For instance, the glass comprises TeO₂, BaO, and Al₂O₃, wherein the BaO and Al₂O₃ are present in sufficient concentrations to provide the glass system with a stress-optic coefficient from about +0.55 and −0.3 Brewsters. In other embodiments, the glass comprises from about 10 mole percent to about 19 mole percent BaO, e.g., from about 12 mole percent to about 18 mole percent, or about 15 mole percent, of BaO and from about 1 mole percent to about 1 mole percent to about 10 mole percent, e.g., from about 3 mole percent to about 8 mole percent, from about 4 mole percent to about 6 mole percent, or about 5 mole percent, of Al₂O₃.

In one embodiment, the glass comprises 80 mole percent of TeO₂, 15 mole percent of BaO, and 5 mole percent of Al₂O₃, wherein the glass has a stress-optic coefficient of about −0.18 Brewsters.

### III. Examples

The examples provided in Tables 2-5 below describe exemplary glasses wherein the glass constituents possess static coordination numbers.

TABLE 2
Exemplary glass formulations.

| | | | Amount (mole percent) |
|---|---|---|---|
| | | Amount of | Necessary to Give |
| Glass | Glass | Glass modifier | a Stress-Optic |
| Formers | modifier | (mole percent) | Coefficient of Zero |
| SiO₂ | SnO | ≧20 | 64 |
| | | ≧40 | |
| | | From 60-70 | |
| | Sb₂O₃ | ≧10 | 36 |
| | | ≧30 | |
| | | From 30-40 | |
| | As₂O₃ | ≧20 | 54 |
| | | ≧30 | |
| | | From 50-60 | |
| | HgO | ≧5 | 15 |
| | | From 10-20 | |
| | Bi₂O₃ | ≧40 | 66 |
| | | From 60-70 | |
| | Tl₂O | ≧10 | 22 |
| | | From 15-30 | |
| P₂O₅ | SnO | ≧20 | 64 |
| | | ≧40 | |
| | | From 60-70 | |
| | Sb₂O₃ | ≧10 | 36 |
| | | ≧30 | |
| | | From 30-40 | |
| | As₂O₃ | ≧20 | 54 |
| | | ≧30 | |
| | | From 50-60 | |
| | HgO | ≧5 | 15 |
| | | From 10-20 | |
| | Bi₂O₃ | ≧40 | 66 |
| | | From 60-70 | |
| | Tl₂O | ≧10 | 22 |
| | | From 15-30 | |
| B₂O₃ | SnO | ≧20 | 44 |
| | | ≧40 | |
| | | From 40-50 | |
| | Sb₂O₃ | ≧10 | 20 |
| | | From 15-25 | |
| | As₂O₃ | ≧20 | 34 |
| | | ≧40 | |
| | | From 30-40 | |
| | HgO | ≧5 | 8 |
| | | From 5-10 | |
| | Bi₂O₃ | ≧40 | 47 |
| | | From 40-50 | |
| | Tl₂O | ≧5 | 12 |
| | | From 5-10 | |
| TeO₂ | SnO | ≧10 | 18 |
| | | From 15-30 | |
| | Sb₂O₃ | ≧5 | 6 |
| | | From 5-10 | |
| | As₂O₃ | ≧8 | 12 |
| | | From 10-15 | |
| | HgO | ≧1 | 2 |
| | | From 0.5-5 | |
| | Bi₂O₃ | ≧15 | 20 |
| | | From 15-25 | |
| | Tl₂O | ≧1 | 3 |
| | | From 0.5-5 | |
| GeO₂ | SnO | ≧20 | 56 |
| | | ≧40 | |
| | | From 50-60 | |
| | Sb₂O₃ | ≧10 | 29 |
| | | ≧20 | |
| | | From 25-35 | |
| | As₂O₃ | ≧20 | 46 |
| | | ≧40 | |
| | | From 40-50 | |
| | HgO | ≧8 | 12 |
| | | From 10-15 | |
| | Bi₂O₃ | ≧30 | 59 |
| | | ≧40 | |
| | | From 55-65 | |
| | Tl₂O | ≧15 | 17 |
| | | From 15-25 | |

The experimental error is ±10%.

Other examples include glasses having the compositions illustrated in Table 3:

TABLE 3
Exemplary glasses comprising SnO and SiO₂.

| Amount of SnO | Amount of SiO₂ | Stress-Optic |
|---|---|---|
| (mole percent) | (mole percent) | Coefficient (Brewsters) |
| 38 | 62 | 0.85 |
| 48 | 52 | −0.47 |
| 54 | 46 | −1.39 |
| 59 | 41 | −1.60 |

The glasses described above in Table 3 were synthesized from silicon dioxide (SiO₂) and tin oxide (SnO). The reagents were melted under an argon pressure of about 0.5 bar in an covered alumina crucible at about 1500° C. for 30 min in an induction furnace. The liquid was then cooled down to room temperature in the crucible by switching off the furnace. The crucible was finally broken to take out yellowish glasses. Because the cooling was slow, no residual mechanical stress was observed in the glasses through the polarimeter. Thus the samples did not need to be annealed at the end of their synthesis. To perform the photoelastic coefficient measurement, glasses were cut in order to obtain samples of about 10×5×5 mm and two parallel sides were polished. The photoelastic coefficient was measured following a Sénarmont or quarter-wave plate compensator method, see for example, H. G. Jerrard, “Optical compensators for measurement of elliptical polarization”, Journal of the Optical Society of America, 1948, 38 (1), 35-59) using a polarimeter (PS-100 Strainoptic). The light source used was two 8 W tungsten halogen bulbs. The sample was strained such that its stress axes were 45° relative to the polarizer axis. In the PS-100 polarimeter the quarter-wave plate is fixed from the sample and the analyzer such that the fast axis of the plate is aligned with the polarizer axis. Under these conditions, extinction was obtained by rotating the analyzer by an angle of θ/2, where θ is the phase difference from the extraordinary and the ordinary rays. The optical path length difference δ was then determined by the equation δ=θλ considering the wavelength λ of 565 nm for applied stresses in the range of 0 to about 6×10⁶ to 13×10⁶ Pa depending on the composition. The stress-optic coefficients were measured using a Sénarmont or quarter-wave plate compensator.

Other examples include glasses having the compositions illustrated in Table 4:

TABLE 4
Exemplary glasses comprising SnO and P₂O₅.

| Amount of SnO | Amount of P₂O₅ | Stress-Optic |
|---|---|---|
| (mole percent) | (mole percent) | Coefficient (Brewsters) |
| 55 | 45 | 0.27 |
| 60 | 40 | −0.62 |
| 66 | 44 | −1.32 |
| 75 | 25 | −2.34 |

The glasses described above in Table 4 were synthesized from ammonium dihydrogen-phosphate (NH₄H₂PO₄) and tin oxide (SnO). The reagents were melted under argon in an alumina crucible at about 1050° C. for 30 min in a muffle furnace. Glasses were then obtained by pouring the liquid on a brass plate at room temperature. They were then annealed at about 250° C. for 2 hours in a muffle furnace and slowly cooled to room temperature (1° C./min) in order to reduce residual mechanical stresses induced during the quenching. To perform the photoelastic coefficient measurement, glasses were cut in order to obtain samples of about 10×10×5 mm and two parallel sides were polished. The stress-optic coefficients were measured using a Sénarmont or quarter-wave plate compensator.

Other examples include glasses having the compositions illustrated in Table 5:

TABLE 5
Exemplary glasses comprising Sb₂O₃ and B₂O₃.

| Amount of Sb₂O₃ | Amount of B₂O₃ | Stress-Optic |
|---|---|---|
| (mole percent) | (mole percent) | Coefficient (Brewsters) |
| 40 | 60 | 0.51 |
| 50 | 50 | −1.33 |

The glasses described above in Table 5 were each synthesized from anhydrous boric oxide (B₂O₃) and antimony oxide (Sb₂O₃). The reagents were melted in air in an alumina crucible at about 1100° C. for 15 min in a muffle furnace. Glasses were then obtained by pouring the liquid on a brass plate at room temperature. They were then annealed at about 300° C. for 2 hours in a muffle furnace and slowly cooled to room temperature (1° C./min) in order to reduce residual mechanical stresses induced during the quenching. To perform the photoelastic coefficient measurement, glasses were cut in order to obtain samples of about 10×10×5 mm and two parallel sides were polished. The stress-optic coefficients were measured using a Sénarmont or quarter-wave plate compensator, as discussed above.

Each of the glasses described in Tables 3, 4, and 5 were annealed at a temperature close to their glass transition temperature for two hours before being slowly cooled to room temperature (1° C./min). Each sample was cut and polished to form a rectangle of about 10×10×5 mm. The stress-optical coefficient was measured for each glass under a uniaxial compressive stress using an aluminum apparatus. The stress-optic coefficients were determined as described above. The applied stress was controlled using a load cell (3190-101, Lebow) and the induced birefringence was measured using a polarimeter (PS-100 Strainoptic).

The examples described in Table 6 are exemplary glasses wherein at least one of the glass constituents possesses a dynamic coordination number.

TABLE 6
Exemplary glasses comprising BaO and TeO₂.

| Amount of BaO | Amount of TeO₂ | Stress-Optic |
|---|---|---|
| (mole percent) | (mole percent) | Coefficient (Brewsters) |
| 10 | 90 | 0.52 |
| 15 | 85 | 0.20 |
| 20 | 80 | −0.27 |

The glasses described above in Table 6 were synthesized from reagent grade BaCO₃ and TeO₂. Glassy TeO₂ was prepared by melting TeO₂ in a platinum crucible for 15 min at 800° C. and quenching from brass plates. Barium tellurite glasses were synthesized from reagent grade BaCO₃ and TeO₂. The reagents were melted for 30 min at 800° C., then quenched into a brass mold heated to 200° C. The glasses were immediately annealed for 4 hrs at 290° C. To perform the photoelastic coefficient measurement, glasses were cut in order to obtain samples of about 10×5×5 mm and two parallel sides were polished.

The photoelastic coefficient was measured following a Sénarmont or quarter-wave plate compensator method (H. G. Jerrard, “Optical compensators for measurement of elliptical polarization”, Journal of the Optical Society of America, 1948, 38 (1), 35-59) using a polarimeter (PS-100 Strainoptic). The light source used was two 8 W tungsten halogen bulbs. The sample was strained such that its stress axes were 450 relative to the polarizer axis. In the PS-100 polarimeter the quarter-wave plate is fixed from the sample and the analyzer such that the fast axis of the plate is aligned with the polarizer axis. Under these conditions, extinction was obtained by rotating the analyzer by an angle of θ/2, where θ is the phase difference from the extraordinary and the ordinary rays. The optical path length difference δ was then determined by the equation δ=θλ considering the wavelength λ of 565 nm for applied stresses in the range of 0 to about 6×10⁶ to 13×10⁶ Pa depending on the composition. The stress-optic coefficients were measured using a Sénarmont or quarter-wave plate compensator.

Raman spectra were acquired on a Bruker RFS100 FT-Raman instrument, operating with an Nd:YAG laser at 235 mW and 1664 nm wavelength. Typically 500 scans were acquired for signal averaging. One such spectrum is provided in FIG. 6.

Glasses of the present invention can also comprise additional additives that may serve to improve the clarity, durability, scratch resistance, or chemical resistance of the glass. In one example, a glass of the present invention further comprises fluoride.

Glasses of the present invention can also be further processed to further include at least one film or chemical coating on a surface of the glass.

### IV. Optical Systems

Another aspect of the present invention provides optical systems comprising a glass element, wherein the glass element comprises a glass that has a substantially optically isotropic response at visible wavelengths when the glass is subjected to anistropic stress. Examples of such glasses useful for optical systems of the present invention and methods of making the same are discussed above.

Another aspect of the present invention provides optical systems comprising a glass element wherein the glass element comprises TeO₂ and a sufficient concentration of BaO to provide the glass with a reduced stress-optic coefficient when subjected to anisotropic stress.

In several examples, the glass element comprises a sufficient concentration of BaO to provide the glass with a stress-optic coefficient from about +0.55 to about −0.35 Brewsters. In other embodiments, the glass element comprises from about 5 mole percent to about 25 mole percent of BaO (e.g., from about 8 mol percent to about 22 mol percent, or from about 10 mol percent to about 20 mol percent). In alternative embodiments, the glass element comprises from about 95 mole percent to about 75 mole percent of TeO₂ (e.g., from about 78 mole percent to about 92 mole percent, or from about 80 mole percent to about 90 mole percent). In other embodiments, the glass element comprises TeO₂ and BaO, wherein the concentration of BaO is greater than about 15 mole percent and less than about 20 mole percent. In still other embodiments, the glass element is formulated according to one of the formulations in Table 8, below.

TABLE 8
Glass Element Formulations

| Amount of BaO | Amount of TeO₂ |
|---|---|
| (mole percent) | (mole percent) |
| 10 | 90 |
| 15 | 85 |
| 20 | 80 |

In one embodiment, the glass element comprises TeO₂ and BaO, wherein the BaO is present in sufficient concentration to provide the glass element with a reduced stress-optic coefficient, e.g., from about +0.65 and −0.35 Brewsters (e.g., from about +0.50 and −0.50 Brewsters, or from about +0.3 and −0.3 Brewsters), at visible wavelengths when the glass element is subjected to anisotropic stress.

The optical system of the present invention is useful because it comprises an optical element that is free, i.e., the glass has a stress-optic coefficient of zero, or substantially free of photoelasticity and/or birefringence at visible wavelengths when subjected to an anisotropic stress.

Furthermore, optical systems of the present invention comprise optical elements that can comprise more than one glass former and/or more than one glass modifier. For example, an optical element comprises TeO₂ as a glass former and BaO as a glass modifier, and a second glass modifier selected from SnO, Sb₂O₃, As₂O₃, Bi₂O₃, HgO, Al₂O₃, or mixtures thereof. In another example, an optical element comprises TeO₂ as a glass former and BaO as a glass modifier, and a second glass former selected from SiO₂, P₂O₅, B₂O₃, TeO₂, and GeO₂.

Optical systems of the present invention include without limitation a video monitor (e.g., a television, (e.g., a rear projection television), a digital projector, (e.g., liquid crystal on silicon, i.e., LCOS), a computer monitor), a light source (e.g., a light bulb), an optical lens, a window, or combinations thereof.

In some embodiments, the optical element comprises an optical fiber, a glass lens, a mirror, an optical shield such as a window, a light filter, or a display screen.

### V. Other Embodiments

While a feature of the present invention may have been described in the context of only one of the illustrated embodiments, such feature may be combined with one or more other features of other embodiments, for any given formulation, method, or apparatus. It will also be appreciated from the above that the formulation of the unique glasses described herein and the operation thereof also constitute methods in accordance with the present invention.

What is claimed is:

1. A lead free glass comprising:
at least one glass former; and
at least one glass modifier selected from SnO, Sb₂O₃, As₂O₃, and HgO,
wherein the glass comprises a sufficient concentration of glass modifier to impart a substantially, optically isotropic response to the glass at visible wavelengths in the presence of an anisotropic stress applied to the glass.

2. The glass of claim 1, wherein the glass former is at least one selected from SiO₂, P₂O₅, B₂O₃, TeO₂, and GeO₂.

3. The glass of claim 2, further comprising a sufficient concentration of glass modifier to impart the glass with a stress-optic coefficient from less than about +1.0 Brewster to about −1.5 Brewsters.

4. The glass of claim 3, further comprising a sufficient concentration of glass modifier to impart the glass with a stress-optic coefficient of about zero.

5. The glass of claim 4, wherein the glass modifier comprises SnO.

6. The glass of claim 5, wherein the glass modifier comprises SnO, and the glass further comprises at least about 20 mole percent of SnO.

7. (canceled)

8. (canceled)

9. (canceled)

10. The glass of claim 2, wherein the glass former comprises SiO₂, P₂O₅, B₂O₃, TeO₂, or any combination thereof.

11. The glass of claim 10, wherein the glass modifier comprises Sb₂O₃.

12. The glass of claim 11, wherein the glass modifier comprises Sb₂O₃, and the glass further comprises at least about 10 mole percent of Sb₂O₃.

13. (canceled)

14. (canceled)

15. (canceled)

16. The glass of claim 10, wherein the glass modifier comprises As₂O₃.

17. The glass claim 16, wherein the glass modifier comprises As₂O₃, and the glass further comprises at least about 20 mole percent of As₂O₃.

18. (canceled)

19. (canceled)

20. (canceled)

21. The glass of claim 10, wherein the glass modifier comprises HgO.

22. The glass of any of claim 21, wherein the glass modifier comprises HgO, and the glass further comprises at least about 5 mole percent of HgO.

23. (canceled)

24. (canceled)

25. (canceled)

26. A method of producing glass comprising:
providing a glass former; and
providing a glass modifier selected from SnO, Sb₂O₃, As₂O₃, HgO, and any combination thereof,
wherein the glass comprises a sufficient concentration of glass modifier to impart a substantially, optically isotropic response to the glass at visible wavelengths in the presence of an anisotropic stress applied to the glass.

27. The method of claim 26, wherein the glass former is SiO₂, P₂O₅, B₂O₃, TeO₂, GeO₂, or any combination thereof.

28. The method of either of claim 27, further comprising a sufficient concentration of glass modifier to impart the glass with a stress-optic coefficient from less than about +1.0 Brewster to about −1.5 Brewsters.

29. The method of claim 28, further comprising a sufficient concentration of glass modifier to impart the glass with a stress-optic coefficient of about zero.

30. The method of claim 26, wherein the glass modifier and the glass former are provided according to an equation:
Σ([x_{fn}×(d_{fn}/N_{Cfn})]+[xₘₙ×(dₘₙ/N_{Cmn})])=0.5,
wherein x_{fn} is the of a single glass former, d_{fn} is the bond distance from the non-oxygen atom(s) and an oxygen atom(s) in the respective glass former, N_{Cfn} is the coordination number of the non-oxygen atom(s) in the respective glass former, and xₘₙ is the concentration of a single glass modifier, dₘₙ is the bond distance from the non-oxygen atom(s) and an oxygen atom(s) in the respective glass modifier, and N_{Cmn} is the coordination number of the non-oxygen atom(s) in the respective glass modifier; or
when a glass former has a dynamic coordination number:
Σ[(xₙ₁×(dₙ₁/N_{Cn1}))+(x_{f}×(d_{f}/N_{Cf})*]=0.5,
wherein the xₙ₁ is the concentration of a single glass constituent having a static coordination number, dₙ₁ is the bond distance from the non-oxygen atom(s) and an oxygen atom(s) in the respective glass constituent, N_{Cfn} is the coordination number of the non-oxygen atom(s) in the respective glass constituent, x_{f} is the concentration of a single glass former having a dynamic coordination number, and (d_{f}/N_{Cf})* is [d_{f}/(N_{Cf}°+β_{C}x_{C})], wherein β_{C} is the rate of change of coordination number with the addition of the glass constituent; and d_{f} is the bond distance from the non-oxygen atom(s) and an oxygen atom(s) in the pure glass former, N_{Cf}° is the coordination number of the non-oxygen atom(s) in the pure glass former, and x_{C} is the concentration of the glass constituent; or
when a glass modifier has a dynamic coordination number:
Σ([xₙ₁×(dₙ₁/N_{Cn1}))+(xₘ×(dₘ/N_{Cm})*])=0.5,
wherein the xₙ₁ is the concentration of a single glass constituent having a static coordination number, dₙ₁ is the bond distance from the non-oxygen atom(s) and an oxygen atom(s) in the respective glass constituent, N_{Cfn} is the coordination number of the non-oxygen atom(s) in the respective glass constituent, xₘ is the concentration of a single glass modifier having a dynamic coordination number, and (dₘ/N_{Cmn})* is [dₘ/(N_{Cf}°+β_{C}x_{C})], wherein βₘ is the rate of change of coordination number with the addition of the glass constituent; and d_{f} is the bond distance from the non-oxygen atom(s) and an oxygen atom(s) in the pure glass former, and N_{Cf}° is the coordination number of the non-oxygen atom(s) in the pure glass former, and x_{C} is the concentration of the glass constituent.

31. The method of claim 30 wherein the glass modifier comprises SnO.

32. The method of claim 31, wherein the glass modifier comprises SnO, and the glass further comprises at least about 20 mole percent of SnO.

33. (canceled)

34. (canceled)

35. (canceled)

36. The method of claim 30, wherein the glass former comprises SiO₂, P₂O₅, B₂O₃, TeO₂, or any combination thereof.

37. The method of claim 36, wherein the glass modifier comprises Sb₂O₃.

38. (canceled)

39. (canceled)

40. (canceled)

41. (canceled)

42. The method of claim 30, wherein the glass modifier comprises As₂O₃.

43. (canceled)

44. (canceled)

45. (canceled)

46. (canceled)

47. The method of claim 30, wherein the glass modifier comprises HgO.

48. (canceled)

49. (canceled)

50. (canceled)

51. An optical system comprising:
an optical element comprising a glass, wherein the glass comprises TeO₂ and BaO, wherein the concentration of BaO is sufficient to impart a substantially, optically isotropic response to the glass at visible wavelengths when subjected to anisotropic stress.

52. (canceled)

53. (canceled)

54. The optical system of claim 51, wherein the optical element comprises a glass, and the glass comprises greater than about 10 mole percent to less than about 20 mol % of BaO.

55. (canceled)

56. The optical system claim 51, wherein the optical element comprises a glass, and the glass comprises a glass modifier selected from SnO, Sb₂O₃, As₂O₃, Bi₂O₃, HgO, Al₂O₃, or mixtures thereof.

57. The optical system of claim 51, wherein the optical element comprises a glass, and the glass comprises a glass former comprising SiO₂, P₂O₅, or combinations thereof.

58. The optical system of claim 51, wherein the optical element is at least one selected from an optical fiber, a lens, a mirror, a window and/or a shield, a light filter, or a display screen, and combinations thereof.

59. The optical system of claim 58 further comprising a light source capable of emitting visible wavelengths of light.

60. (canceled)

61. (canceled)

62. A method of formulating a glass having a slightly positive, zero, or slightly negative stress-optic coefficient comprising
providing a glass former and a glass modifier, wherein either of the glass former or the glass modifier has a dynamic coordination number, and the modifier is present in a concentration that provides the glass with a reduced stress-optic coefficient at visible wavelengths when the glass is subjected to anisotropic stress.

63. (canceled)

64. The method of claim 62, wherein the glass former is TeO₂.

65. The method of claim 64, wherein the glass modifier is BaO.

66. The method of claim 65, wherein the glass modifier is present in a concentration that provides the glass with a stress-optic coefficient from about +0.55 to about −0.35 Brewsters at visible wavelengths when the glass is subject to anisotropic stress.

67. (canceled)

68. (canceled)

69. (canceled)

70. (canceled)

71. A method of producing a glass, comprising:
providing a glass modifier selected from SnO, Sb₂O₃, As₂O₃, Bi₂O₃, HgO, or mixtures thereof; and
providing a glass former selected to produce a glass base of SiO₂, P₂O₅, B₂O₃, TeO₂, GeO₂, or combinations thereof,
wherein the glass modifier and the glass former are provided in concentrations are provided according to an equation:
Σ([x_{fn}×(d_{fn}/N_{Cfn})]+[xₘₙ×(dₘₙ/N_{Cmn})])=0.5,
wherein x_{fn} is the of a single glass former, d_{fn} is the bond distance from the non-oxygen atom(s) and an oxygen atom(s) in the respective glass former, N_{Cfn} is the coordination number of the non-oxygen atom(s) in the respective glass former, and xₘₙ is the concentration of a single glass modifier, dₘₙ is the bond distance from the non-oxygen atom(s) and an oxygen atom(s) in the respective glass modifier, and N_{Cmn} is the coordination number of the non-oxygen atom(s) in the respective glass modifier; or
when a glass former has a dynamic coordination number:
Σ[(xₙ₁×(dₙ₁/N_{Cn1}))+(x_{f}×(d_{f}/N_{Cf})*]=0.5,
wherein the xₙ₁ is the concentration of a single glass constituent having a static coordination number, dₙ₁ is the bond distance from the non-oxygen atom(s) and an oxygen atom(s) in the respective glass constituent, N_{Cfn} is the coordination number of the non-oxygen atom(s) in the respective glass constituent, x_{f} is the concentration of a single glass former having a dynamic coordination number, and (d_{f}/N_{Cf})* is [d_{f}/(N_{Cf}°+β_{C}x_{C})], wherein β_{C} is the rate of change of coordination number with the addition of the glass constituent; and d_{f} is the bond distance from the non-oxygen atom(s) and an oxygen atom(s) in the pure glass former, N_{Cf}° is the coordination number of the non-oxygen atom(s) in the pure glass former, and x_{C} is the concentration of the glass constituent; or
when a glass modifier has a dynamic coordination number:
Σ[(xₙ₁×(dₙ₁/N_{Cn1}))+(xₘ×(dₘ/N_{Cm})*]=0.5,
wherein the xₙ₁ is the concentration of a single glass constituent having a static coordination number, dₙ₁ is the bond distance from the non-oxygen atom(s) and an oxygen atom(s) in the respective glass constituent, N_{Cfn} is the coordination number of the non-oxygen atom(s) in the respective glass constituent, xₘ is the concentration of a single glass modifier having a dynamic coordination number, and (dₘ/N_{Cm})* is [dₘ/(N_{Cf}°+β_{C}x_{C})], wherein βₘ is the rate of change of coordination number with the addition of the glass constituent; and d_{f} is the bond distance from the non-oxygen atom(s) and an oxygen atom(s) in the pure glass former, and N_{Cf}° is the coordination number of the non-oxygen atom(s) in the pure glass former, and x_{C} is the concentration of the glass constituent.

72. (canceled)
